(19) United States
(12) Patent Application Publication
(10) Pub. No.: US 2008/0165525 A1
(43) Pub. Date: Jul. 10, 2008

(54) Christmas Tree Replica

(76) Inventor: Hsiu-Tsen Chang, Taipei (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(21) Appl. No.: 11/620,692

(22) Filed: Jan. 7, 2007

(51) Int. Cl. F21S 6/00

(52) U.S. Cl. 362/123

(57) ABSTRACT

A Christmas tree replica includes a shank extending upright from and supported by the base, a spiral frame connected to the shank and light bulbs electrically connected to one another via cables which are received inside the passage of the spiral frame. The light bulbs are axially extending away from the spiral frame such that decorative effect is enhanced.

### BACKGROUND OF THE INVENTION

1. Field of Invention

The present invention relates to a Christmas tree replica, and more particularly to a Christmas tree replica having a shank, a base securely connected to a distal end of the shank, a disk connected to a top portion of the shank, a spiral frame spirally tapered upward and extending downward from the disk and light bulbs axially extending from the spiral frame so as to form a Christmas tree.

2. Description of the Prior Art

A genuine Christmas tree costs a fortune and the afterward disposal of the Christmas tree takes a lot of effort to dispose the used Christmas free. As a result, urban people tend to buy artificial Christmas tree instead of a real tree during the Christmas time.

One of the conventional artificial Christmas tree is shown in FIG. 9 and has a upward tapered spiral frame (5) spirally extending downward from a top of a shank which is securely connected to a base to support the shank and the spiral frame. Inside the frame (5), a passage (51) is defined along a length of the spiral frame (5). Multiple light bulbs (52) electrically connected to one another are embedded or received inside the passage (51). That is, the light bulbs (52) are literally “lying” inside the spiral frame (5). Therefore, when the string of the light bulbs (5) is connected to a power outlet, a spirally shaped light is presented.

When this type of Christmas tree is introduced to the market, there is no attraction to the potential customers in that there are no twigs or branches as the real one does. Furthermore, the lay down light bulbs (52) inside the passage (51) show nothing but light. In addition, the light from the light bulbs (52) is partially blocked by side faces of the spiral frame (5). All in all, the conventional Christmas tree is not attractive and shows no sign of joyfulness.

To overcome the shortcomings, the present invention tends to provide an improved Christmas tree replica to mitigate the aforementioned problems.

### SUMMARY OF THE INVENTION

The primary objective of the present invention is to provide an improved Christmas tree replica having a shank extending upward from a base, a spiral frame tapered upward and spirally extending downward along the shank and multiple light bulbs alternately and axially extending upward and downward from the spiral frame such that a spiral frame with light emitted axially from the spiral frame shows the real spirit of a genuine Christmas tree.

Other objects advantages and novel features of the invention will become more apparent from the following detailed description when taken in conjunction with the accompanying drawings.

### BRIEF DESCRIPTION OF THE DRAWINGS

FIG. 1 is a side plan view of the Christmas tree replica of the present invention;

FIG. 2 is a partially enlarged perspective view of the spiral frame of the present invention;

FIG. 3 is a cross sectional view taken from line 33 in FIG. 2;

FIG. 4 is a

FIG. 5 is a

FIG. 6 is a schematic side plan view of another embodiment of the present invention;

FIGS. 7 and 8 are schematic views showing different embodiments of the present invention; and

FIG. 9 is a partially enlarged perspective view of the spiral frame of the conventional Christmas tree.

### DETAILED DESCRIPTION OF THE PREFERRED EMBODIMENT

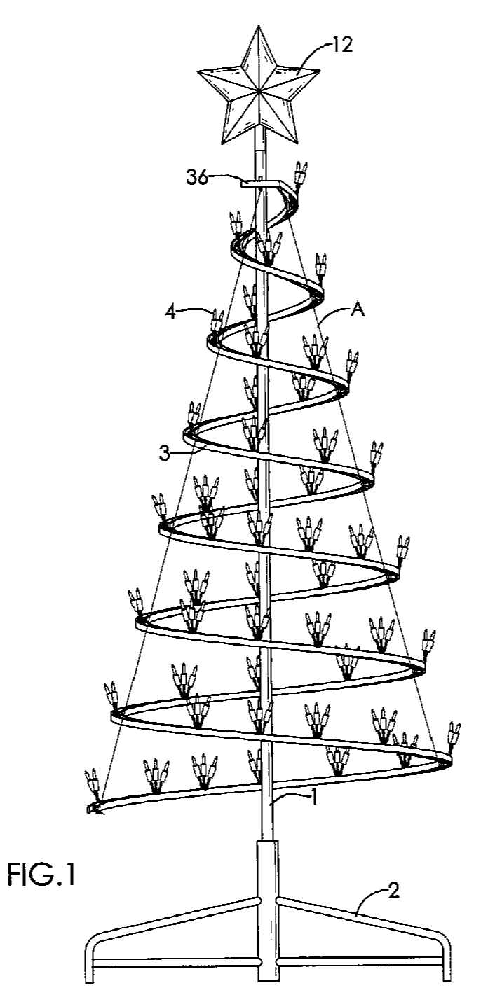

With reference to FIG. 1 it is noted that the Christmas tree replica in accordance with the present invention includes a shank (1) extending upward from a base (2), a spiral frame (3) tapered upward along the shank (1) and extending downward along the shank (1) and light bulbs (4) electrically connected to one another.

The shank (1) is supported by the base (2) such that the shank (1) is able to stand upward from the base (2). At a top free end of the shank (1), there is provided with a decorative element (12), preferably a star.

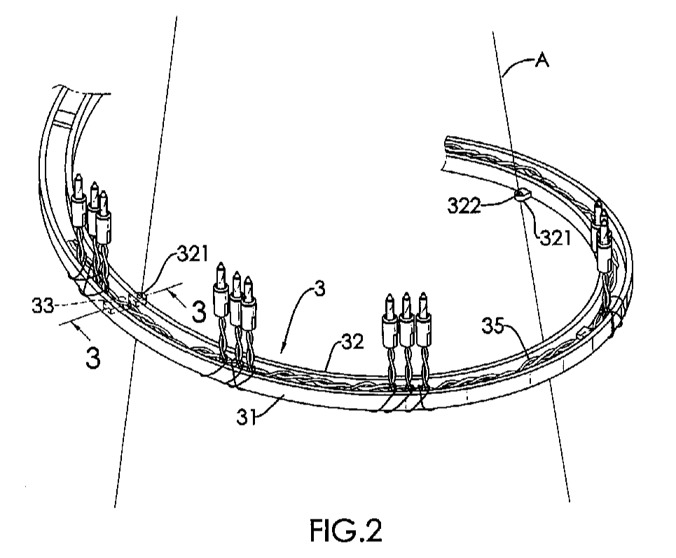

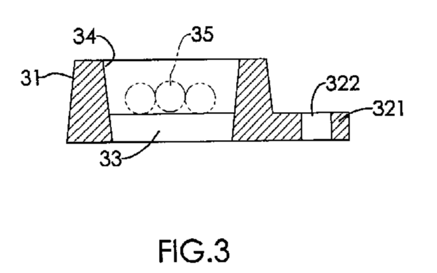

With reference to FIGS. 2 and 3, it is noted that the spiral frame (3) is composed of an outer frame (31), an inner frame (32) and a rib (33) intermittently formed between the outer frame (31) and the inner frame (32) to interlock the outer frame (31) to the inner frame (32). Due to the provision of the rib (33), a passage (34) is defined between the outer frame (31) and the inner frame (32) such that cables (35) electrically connecting the light bulbs (4) are able to be received in the passage (34).

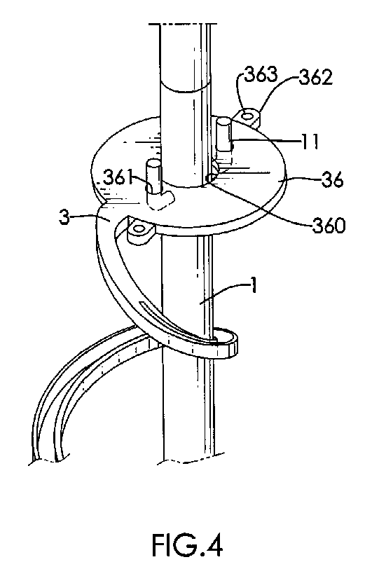

With reference to FIG. 4., it is noted that at a free end of the spiral frame (3), a disk (36) is formed therewith and has a through hole (360) to allow extension of the shank (1) and two positioning holes (361) defined in a periphery adjacent to the though hole (360). Corresponding to the two positioning holes (361), two L shaped fingers (II) are formed on two opposed sides of the shank (1) such that the two L shaped fingers (ii) are able to extend through the two positioning holes (361) and the disk (36) is supported by the two L shaped fingers (11).

In order to maintain stability of the spiral frame (3) relative to the shank (I), the disk (36) further has two ]edges (362) integrally formed on two opposed sides of an outer peripheral edge thereof and each ledge (362) has a hole (363) defined through the ledge (362).

Referring to FIGS. 1, 2 and 3, it is also noted that the spiral frame (3) has multiple second ledges (321) formed and extending out from an inner peripheral edge of the inner frame (32) and each second ledge (321) has a second hole (322) defined therethrough. Thus strings (A) are able to be secured to the ledge (362) after passing through the hole (363). Subsequent secured engagement with the second ledges (321) after passing though the second holes (322), the strings (A) are able to maintain the stability of the spiral frame (3) to the shank (1).

In addition, the cable (35), as previously described, are lied inside the passage (34). But the light bulbs (4) are securely connected to the outer frame (31) using the cables (A) as the securing element to fix the light bulbs (4) to the outer frame (31).

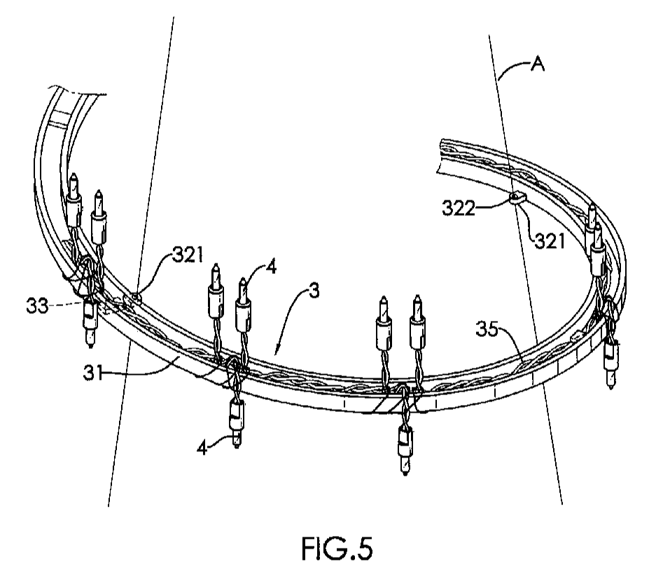

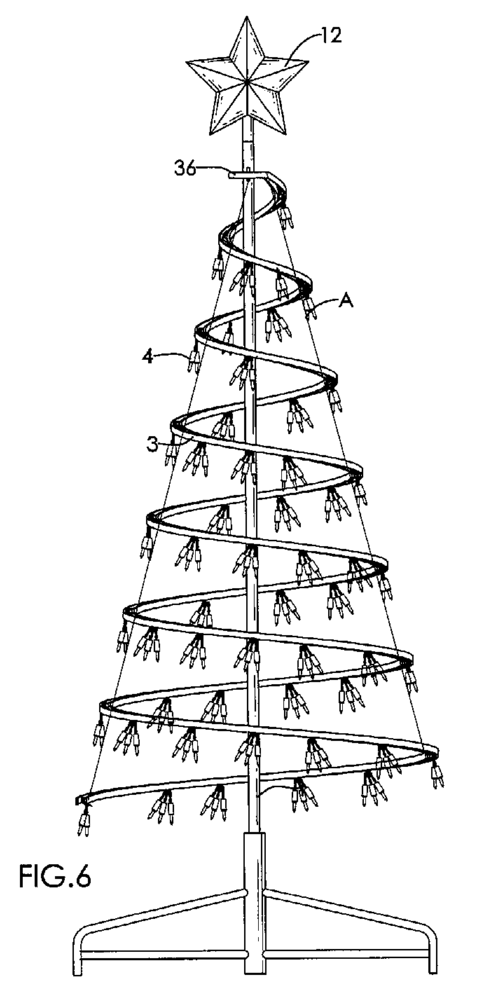

With reference to FIGS. 1, 5 and 6, it is noted that the light bulbs (4) are axially extending outward from the spiral frame (3). That is, each light bulb (4) is substantially extending upright in relation to the spiral frame (3). The light bulb (4) may be extending upright or downward relative to the spiral frame (3), as shown in FIGS. 1 and 6. Alternatively, some of the light bulbs (4) may be extending upward and some light bulbs (4) may be extending downward to diverse the variations of the Christmas tree replica of the present invention. Also, the decorative effect is enhanced due to the variation of the extending directions of the light bulbs (4).

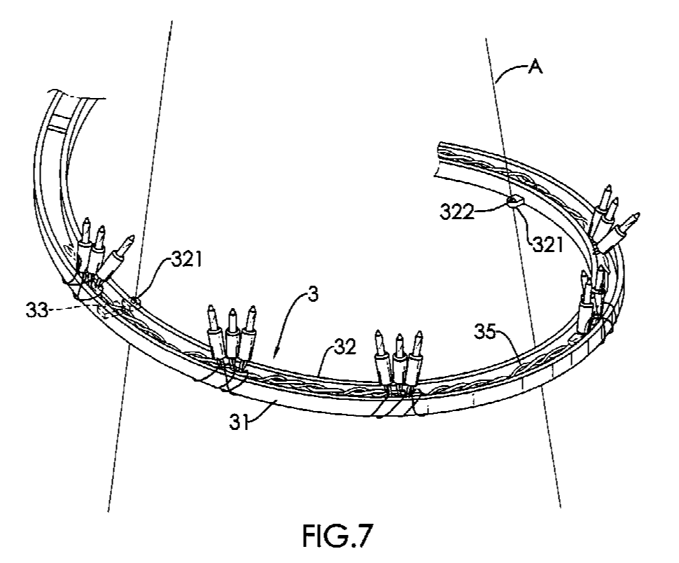

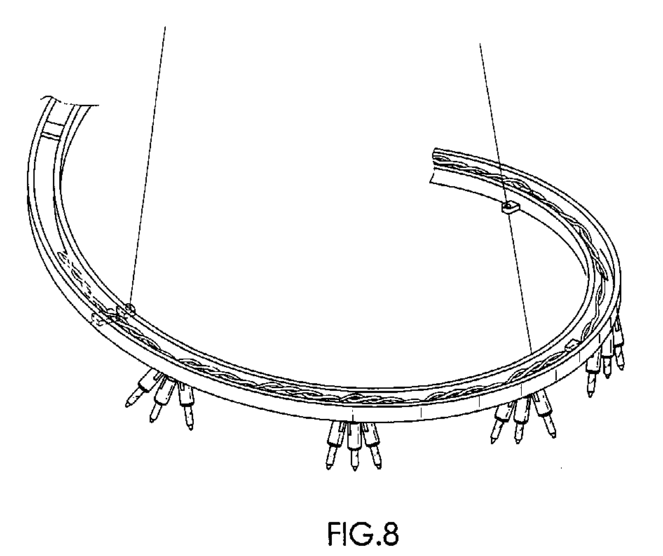

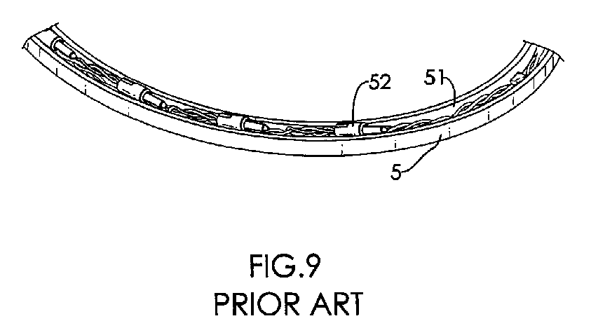

With reference to FIGS. 7 and 8, it is noted that the arrangement of the bulbs (4) is immediately adjacent to the spiral frame (3), unlike the previous embodiment which is extended away from the spiral frame (3) via cables (35). The bulbs (4) may be extended upward or downward relative to the spiral frame (3) as shown in the accompanying drawings.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A Christmas tree replica comprising:
a base;
a shank extending upright from and supported by the base, the shank having a decorative element formed on a top free end thereof;
a spiral frame connected to the shank, the spiral frame being tapered upward relative to the shank and extending downward along the shank, the spiral frame having an outer frame, an inner frame, ribs intermittently formed between the outer frame and the inner frame interlocking the outer frame and the inner frame and a passage defined between the outer frame and the inner frame;
light bulbs electrically connected to one another via cables which are received inside the passage of the spiral frame, the light bulbs axially extending away from the spiral frame such that decorative effect is enhanced.

2. The Christmas tree replica as claimed in claim 1, wherein the spiral frame has a disk formed on a top free end thereof and having two positioning holes defined to correspond to two fingers extending from the shank so that after extension of the two fingers through the two corresponding two through holes, the disk as well as the spiral frame is connected to and supported by the shank.

3. The Christmas tree replica as claimed in claim 2, wherein the disk has two ledges formed on two opposed sides of the disk and each ledge has a hole defined to allow extension of a string, the spiral frame has multiple second ledges formed on an outer periphery of the outer frame and each second ledge has a second hole to allow extension of the string so that after the string passes through the hole and the second holes with secured engagement with the ledges and the second ledges, stability of the spiral frame to the shank is maintained.

4. The Christmas tree replica as claimed in claim 1, wherein the light bulbs are extending upward relative to the spiral frame.

5. The Christmas tree replica claimed in claim 1, wherein the light bulbs are extending downward relative to the spiral frame.

6. The Christmas tree replica as claimed in claim 1, wherein the light bulbs are extending upward and downward relative to the spiral frame.
